(19) United States
(12) Patent Application Publication
(10) Pub. No.: US 2014/0222670 A1
(43) Pub. Date: Aug. 7, 2014

(54) CONTACTLESS PAYMENT APPLICATION MANAGEMENT

(71) Applicant: BARCLAYS BANK PLC, London (GB)

(72) Inventor: Aaron CONCANNON, London (GB)

(73) Assignee: BARCLAYS BANK PLC, London (GB)

(21) Appl. No.: 13/756,961

(22) Filed: Feb. 1, 2013

(51) Int. Cl. G06Q 20/32

(52) U.S. Cl. CPC G06Q 20/3278
USPC 705/41

(57) ABSTRACT

A system and method for completing a financial transaction using contactless payment applications within a mobile device is disclosed. The mobile device may include at least one mobile payment card application and at least one mobile wallet application designed to manage one or more mobile payment card applications stored on the mobile device. Conflicts between the requirements for the mobile payment card application and the wallet application regarding activation of the contactless mobile payment card application may be resolved through the use of payment card and wallet applications stored in the handset of the mobile device, as well as card payment applications, wallet applications, and a platform specifying a framework for managing contactless applications stored in a SIM component of the mobile device.

### TECHNICAL FIELD

The present application is directed to systems and methods for contactless payment services, such as Near Field Communication (NFC) based mobile payment services. In particular, the application is directed to managing the activation of contactless payment applications residing within the same mobile device.

### BACKGROUND OF THE INVENTION

Mobile application payment services offer consumers an alternative payment method. Instead of paying with cash, check, or a credit card, a consumer may complete purchase transactions using an application running on a mobile device, such as a smartphone. Some mobile devices have begun to incorporate contactless payment technology, allowing communications between two devices to authenticate and complete payment transactions at a point of sale terminal without physical contact or connection. Proximity communication systems, such as Near Field Communication (NFC), have been included in mobile devices to enable the device to complete contactless payment transactions through radio communication. NFC equipped devices typically include a controller and an antenna, and have a range limited to no more than a few centimeters. This short range allows for secure communications between proximity communication devices, making NFC ideal for secure contactless financial transactions.

Proximity communication systems, such as NFC, including an antenna have been incorporated into mobile devices that also store secure contactless payment software applications. These contactless payment software applications may provide a user interface for initiating and managing contactless financial transactions, and may execute instructions to provide authentication, verification, and completion of the transactions. The contactless payment software applications may take the form of individual card applications related to a credit card or bank account number. Additionally, a mobile wallet software application may be present within the mobile device, wherein the mobile wallet organizes and provides access to the individual card applications.

Some mobile wallet applications require that the mobile wallet be the single point of control for both activating and deactivating the card applications. In order to ensure that the contactless payments and account information of the customer remain secure, a bank or other institution providing a card application may wish to manage activation of the contactless payment card application from within the card application itself. In devices that include both individual payment applications and mobile wallet applications, conflicts may occur depending on the requirements of each application. For example, there may be a conflict if the wallet contains multiple payment card applications, and one or more of the applications contains rules making that application the default application. When one payment card application is set as the default and activation of another payment card application is attempted, or when more than one application requests that its status be set to “activated” in a given situation, conflicts will arise requiring the mobile wallet to make adjustments such as activating and deactivating the various applications according to its conflict resolution rules. What is needed is a system and method for managing contactless payment applications within a mobile device when there are conflicting requirements regarding management of the activation of the contactless application.

U.S. Patent No. 8,196,131 to von Behren et al (“von Behren”) describes a method and system for payment application lifecycle management in a contactless smart card. Von Behren discloses a wallet software application stored in the handset, as well as card software applications and a control software application stored in a Secure Element of a mobile device. Von Behren discloses that a user may engage the control software application within the Secure Element to give commands to activate, deactivate, prioritize, delete and install card software applications on the Secure Element. However, von Behren does not disclose joint card activation between both a payment card application residing on the handset and the wallet application. Therefore, von Behren does not teach or suggest a method and system to resolve conflicts that may occur within a mobile device when a card payment application requires activation to be managed within the card payment handset application itself, while a wallet application which manages all card payment application on the mobile device requires that be the single point for activating and deactivating applications.

### SUMMARY OF THE INVENTION

The present application is directed to a system and method for completing a financial transaction using contactless payment applications within a mobile device. According to some embodiments, a mobile device may be equipped with a proximity communication technology, such as NFC. The mobile device may further include at least one mobile payment card application and at least one mobile wallet application. The mobile payment card application may include certain requirements designed to ensure that security of financial transactions as well as the privacy of the customer's account and personal information is maintained. The mobile wallet application may be designed to manage one or more mobile payment card applications stored on the mobile device, and may include requirements allowing the wallet application to be the single point of control for activating and deactivating the card applications.

Conflicts between the requirements for the at least one mobile payment card application and the at least one wallet application regarding activation of the contactless mobile payment card application may be resolved through the use of payment card and wallet applications stored in the handset of the mobile device, as well as card payment applications, wallet applications, and a platform specifying a framework for managing contactless applications stored in a SIM component of the mobile device.

### BRIEF DESCRIPTION OF THE DRAWINGS

FIG. 1 illustrates an example of a mobile device equipped for making contactless payments according to the systems and methods of the present application.

FIG. 2 is an illustration of the handset and Secure Element (SIM) components of the mobile device used in a mobile payment system according to one aspect of the present invention.

FIG. 3 is an illustration of the activation of a mobile banking payment application through a card application, operating in an internal mode using the EMV standard.

FIG. 4 is an illustration of activation in a situation requiring conflict resolution between the requirement of a card application and a mobile wallet application.

FIG. 5 is an illustration of wallet integration with a card application according to one embodiment of the present invention.

### DETAILED DESCRIPTION

A system and method for managing the activation of contactless payment applications in a mobile device is disclosed. The system and method include a mobile device including a proximity communication technology allowing the device to be used to complete contactless payment transactions at point of sale terminals or other proximity communication enabled devices. Card payment applications and wallet payment applications stored within the mobile device provide a user interface for completing contactless payment transactions. These applications also contain program requirements for the activation of a contactless payment application, as well as instructions for implementing a process to resolve conflicts in activation requirements.

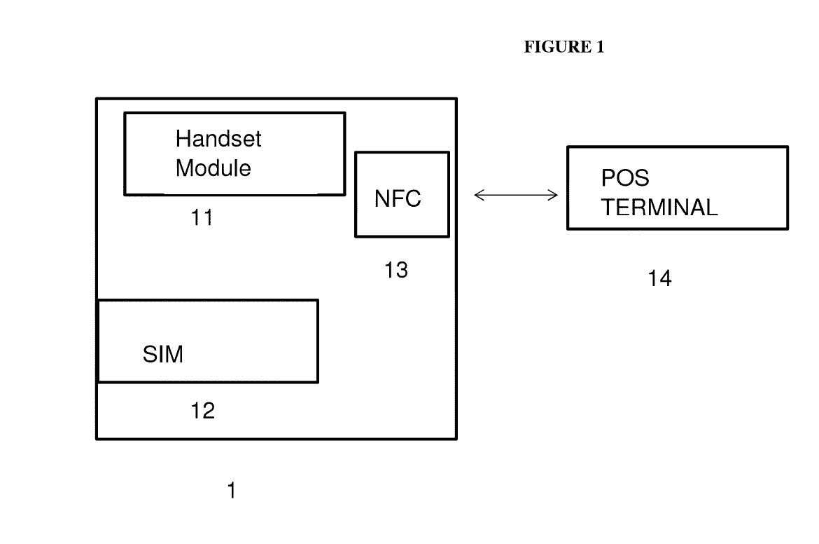

As shown in FIG. 1, a typical mobile payment system according to some embodiments of the present application may include a mobile device, or handset, 1 and a point of sale (POS) terminal 14. The mobile device 1 may include handset module 11, a Secure Element such as a SIM card 12, and NFC device 13. Handset module 11 may include software programs or applications executed by the mobile device. Secure Element, such as SIM Card 12, may store control applications or other software applications. During a contactless payment transaction, the NFC device 13 in the mobile device 1 may act as a transmitter to send payment information, including an account number. The POS terminal 14 may additionally include an NFC device, which acts as a reader to receive the payment information sent by the mobile device 1. Information required to complete the financial transaction is transmitted between the POS terminal and the mobile device using the NFC devices in each.

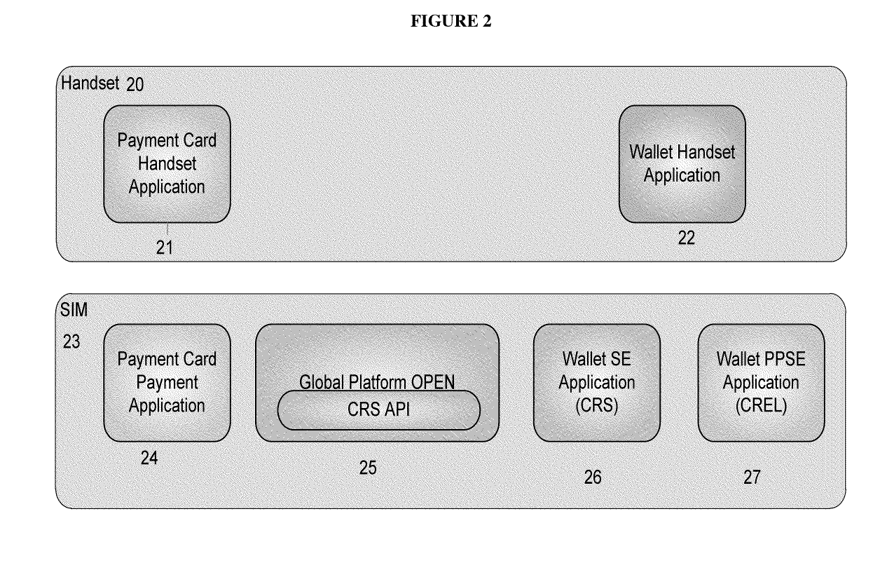

FIG. 2 is an illustration of the architecture of the mobile device 1. The mobile device handset 20 may include a local memory, a display, and user input interface. The user input interface may include a keypad, buttons, and/or switches. Alternatively, the display may comprise a touch-screen, wherein the user input is displayed as selectable icons on the touch screen display itself. A payment card handset application 21 is stored within the local memory of the handset 20. This payment card handset application 21 acts a user interface for the payment service of the institution providing the card handset application 21. The local memory additionally includes a wallet handset application 22 stored thereon. The wallet handset application 22 acts as a user interface for a virtual wallet service accessible through the wallet handset application 22.

As mentioned above, the mobile device may also include a Secure Element, such as SIM card 23. The Secure Element 23 stores control applications which interact with the handset applications 21, 22 in order to control contactless payment transactions. Control applications, stored in the Secure Element may include a Payment Card Payment Application 24, such as a MasterCard payment application, a Secure Element platform 25 supporting a Contact Registry Service (CRS) Application Program Interface (API), such as GlobalPlatform OPEN. The GlobalPlatform OPEN used in the mobile device may include Amendment C specifications, including memory for Security Domains to facilitate the delegation of application management to third party domains. The payment card application 24 may include a registry of business rules and requirements related to the activation and use of the payment card application in contactless payment transactions. Wallet control applications 26, 27 may also be included in the Secure Element. These wallet applications may include a CRS Wallet Secure Element Application 26 and a Contactless Registry Event Listener (CREL) Wallet Application 27. The CRS wallet Secure Element Application 26 may contain business rules and requirements for contactless activation of the various payment card applications managed by the wallet applications. The CREL wallet application 27 may be a proximity payment service environment (PPSE) application that manages which payment cards are available for completing contactless payment transactions through a contactless interface. The payment card applications 21, 24 may interact with the wallet applications 22, 26, 27 through the Secure Element platform 25.

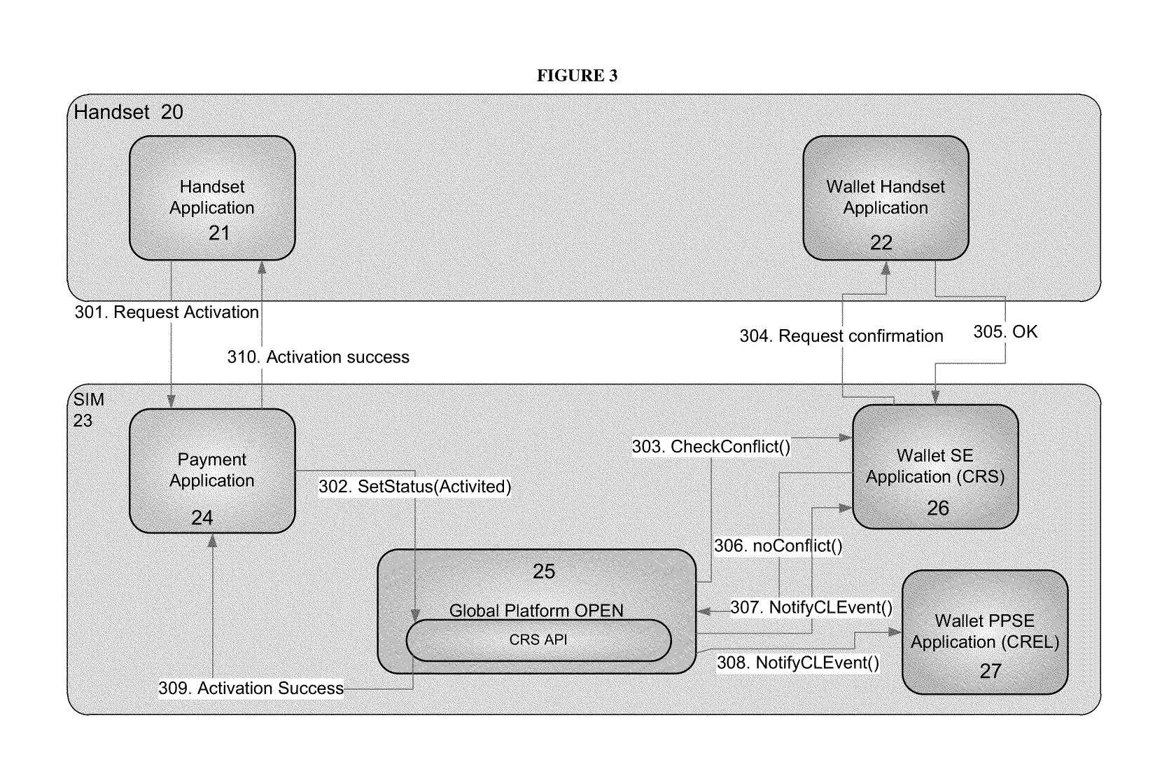

The contactless payment card application may be activated through the payment card applications themselves, operating in a Europay MasterCard, Visa (EMV) standard internal mode. As shown in FIG. 3, a user accesses the payment card handset application 22 to activate the contactless payment card application. Through the payment card handset application, which provides a user interface, a user initiates a request for contactless activation. This request in the handset application 22 triggers the payment card payment application 24 within Secure Element 23 to request contactless activation. The applications within the Secure Element 23 maintain responsibility for managing the PPSE, operating in EMV internal mode. The CRS wallet application 26 manages the activation according to its internal rules, and can trigger the wallet handset application 22 to provide a user interface for conflict resolution when required. If the activation request from the payment card applications is successful, the Secure Element platform 25 notifies the wallet applications and the PPSE of the change implementing the payment card application as the active payment card application. Upon receipt of the activation event, the PPSE wallet application 27 updates the PPSE to contain the payment card application's Application Identifiers (AIDs).

FIG. 3 illustrates contactless payment activation in an event where no conflicts are found. As shown in FIG. 3, a Request Activation 301 is triggered between the payment card handset and Secure Element applications 21, 24. The payment card payment application 24 then sets its status to activated, and transmits this set status to the Secure Element platform 25 at 302. The Secure Element platform 25 interacts with the CRS wallet application 26 to perform a conflicts check 303, and the CRS wallet application sends a request confirmation 304 to the wallet handset application 22. The wallet handset application 22 checks for any conflicts regarding activation of the payment card applications 21, 23, and returns a confirmation “OK” 305 to the CRS wallet application 26 when no conflicts are found. The CRS wallet application 26 then sends a “no conflict” confirmation 306 back to the Secure Element platform 25, which sends notifying event confirmations to the secure element wallet applications 26, 27. The wallet applications 26, 27 then update the PPSE to contain the AID of the now activated payment card application for use in contactless payment transactions. The Secure Element platform 25 sends a notification of activation success 309 to the payment card payment application 24, which relays the notification success at 310 to the payment card handset application. Upon receipt of this notification 310, the payment card handset application may be used to complete contactless payment transactions.

Activation through the payment card applications as described above ensures that activation of the contactless payment service is within the payment card application, which may be PIN controlled to protect user privacy and ensure security of the transactions. Therefore, the payment card application itself, and its service provider, retain control of the activation and any issues with an application outside the control of the payment card service provider activating the payment card application are avoided. The process in FIG. 3 additionally allows the wallet applications to control and manage the activation through the CRS application, and allows the wallet application to maintain control over any conflicts that may arise. Activation events completed through the process shown in FIG. 3 are managed within the applications of the Secure Element, and are cryptographically protected by the access control mechanisms therein.

In certain instances, activation requests from the payment card applications 21, 24 may cause conflicts within the PPSE and wallet applications. In these circumstances, the request will fail and the wallet handset application will automatically launch a user interface for the user to manage and resolve the conflict. After the wallet applications complete the conflict resolution, the payment card applications send a “get status” request through the Secure Element platform to check that the payment card application has become active. This process ensures that the wallet applications remain the central point for managing any activation conflicts that arise among the various payment card applications that maybe included in the mobile device.

A conflict may arise when one card has been set as the default card within the wallet application, but the user has requested for a second card to be made the default card. In order to resolve conflicts, the wallet application may launch a user interface which allows the user to make a selection of which card to place into the activated state. This user interface may indicate the currently activated card and the card requesting to be activated. The user interface may allow the user to make a decision as to which of the two cards is placed into the activated state. This decision could be stored as a setting within the wallet application, or the decision may be used only for the current payment transaction the user is attempting to initiate.

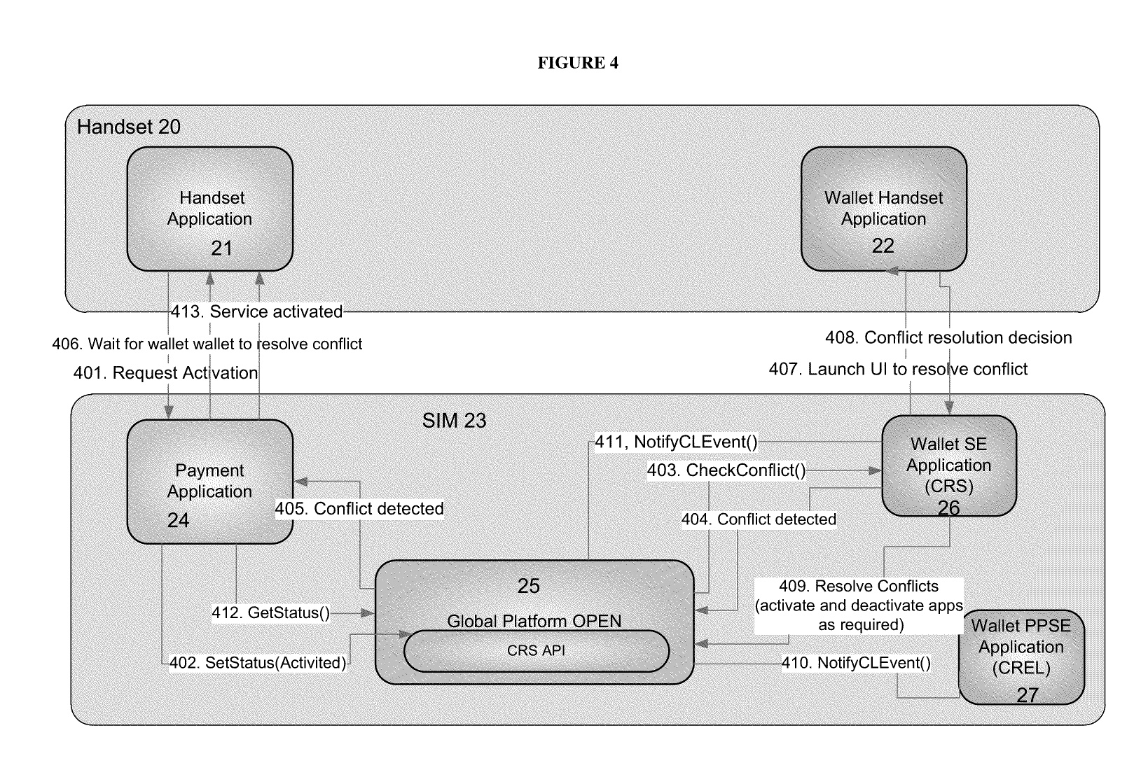

FIG. 4 shows activation of a payment card application in a process that first requires conflict resolution within the mobile wallet. As shown in FIG. 4, an activation request 401 is triggered between the payment card handset and Secure Element applications 21, 24 through a user input within the handset application 21. The payment card payment application 24 sets its status to activated, and transmits this activated status to the Secure Element platform 25 at 402. The platform 25 interacts with the CRS wallet application 26 to check for any conflicts. If a conflict is detected, a notification 404 that a conflict has been detected is sent to the platform 25, which notifies the payment card application 24 that a conflict has been detected at 405. The payment card handset application is notified, and instructs the payment card payment application to wait for the wallet to resolve the conflict at 406.

Upon detection of the conflict, the CRS wallet application 26 automatically sends a command 407 to the wallet handset application 22 to launch a user interface for conflict resolution. Through the user interface, a user resolves the conflict 408 by instructing changes to the PPSE such as activating or deactivating certain of the payment card applications in the mobile device, or changing the parameters and status settings of various applications. These instructions are received 409 by the wallet applications 26, 27 within the Secure Element, which interact with the Secure Element platform 25 to resolve the conflicts. As noted above, resolution of the conflicts may include activation and deactivation of various payment card applications managed by the wallet applications as may be required. Upon completion of the conflict resolution, the Secure Element platform 25 sends a notifying event 410 transmission to the CREL wallet application 27 containing the PPSE, which updates the information within the PPSE accordingly. A notification of the conflict resolution 411 is also sent to the CRS wallet application 26.

The payment card payment application 24 within the Secure Element periodically sends status requests 412 to the Secure Element platform 25 during conflict resolution. Upon notification that the conflict has been resolved and the status of the payment card application has been set to activated, the payment card payment application 24 notifies the payment card handset application 21 at 413 that the payment card handset application is now activated. Contactless payment financial transaction services within the payment card handset application are then available to the user.

In the method and system described herein, the payment card applications may be governed by business rules. According to one embodiment, the business rules may be included within the payment card handset application 21. These business rules for the payment card applications may require that the activation of the contactless payment service happens within the payment card application itself. However, additional business rules for the payment card applications may establish that it is acceptable for deactivation of the payment card application to happen outside of the application itself, such as through a wallet application or through another payment application within the device making itself the default payment application. In order to ensure that activation is done within the payment card handset application 21, while allowing deactivation to occur outside the card application, the service provider of the payment card application may enhance metadata within the payment card handset application 21 to include a “wallet activation allowed” flag that can be used to establish the wallet user interface behavior. If the flag is set to “yes,” the service provider payment card application is allowed to be completely managed by the wallet application. However, if the flag is set to “no,” then options for managing the payment card application will depend on whether the application is active or inactive.

When the application is inactive, instead of an “on/off” control, the application user interface displayed to a user through payment card handset application 21 would display a selectable command to launch the payment card application to start the contactless financial transaction service of the application. When the application is active, the user interface may display an “on/off” control to allow the user to disable the application so that another application may be activated.

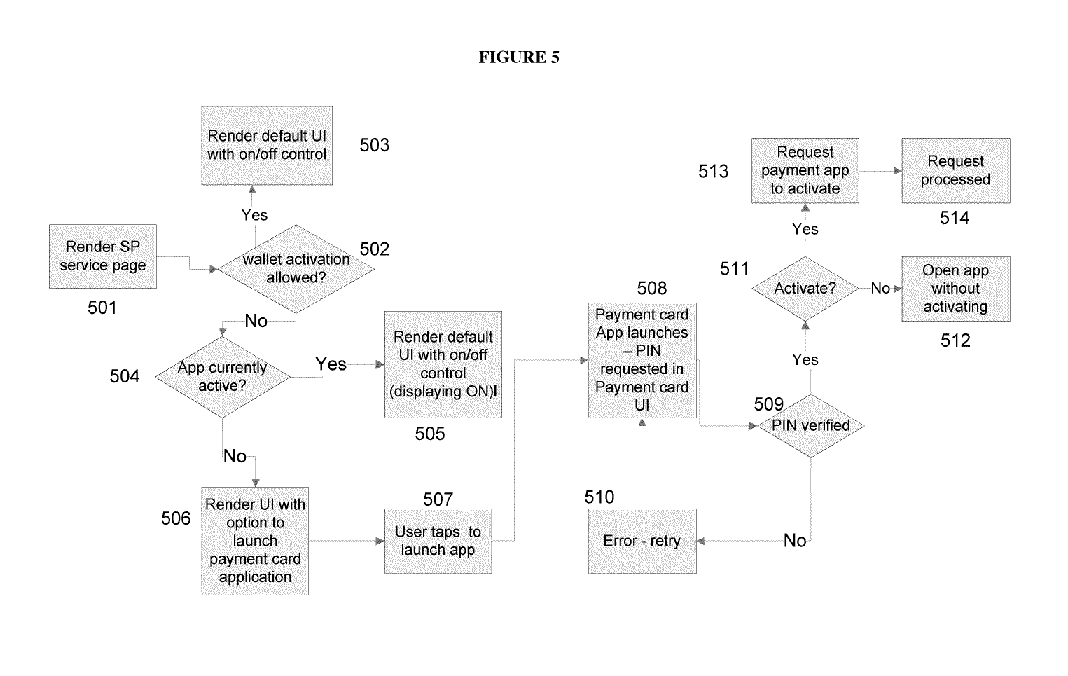

FIG. 5 illustrates the process of wallet integration for a payment card application. A service provider service page is rendered at 501, and a check is performed to see if wallet activation is allowed at 502. If wallet activation is allowed, a default user interface is rendered at 503 that includes an “on/off” control. If wallet activation is not allowed, a check is made at 504 to determine the payment card application is currently active. If the application is active, a default user interface is rendered at 505 that includes an “on/off” control, displaying a status of “on.”

However, if the application is not currently active, a user interface with a selectable option to launch the payment card application to enable the payment card contactless payment service is rendered at 506. A user selects the option to launch the payment card application at 507, which initiates the payment card application on the user device. The payment card application launches and displays a PIN request on the payment card user interface at 508. After a user inputs a PIN, a check is performed at 509 to determine if the PIN is verified. If the PIN is not verified, the user is notified of an error and directed to retry the PIN at 510. If the PIN is verified, the user is presented with an option to activate the payment card application at 511. If the user chooses not to activate the application, the application is opened without first activating the contactless payment card service associated with the application at 512. If the user chooses to activate the payment card application, a request to activate the payment card application is initiated at 513. This request may then be then processed at 514 according to the embodiments shown in FIGS. 3 and 4.

In the foregoing, the invention has been described with reference to particular embodiments. However, it is evident that various modification and changes may be made thereto without departing from the broader scope of the invention.

1. A system for resolving activation conflicts within a contactless mobile payment service device, the system comprising:
a mobile device comprising a display, user input interface, local memory and a Secure Element;
a payment card application stored within the local memory, wherein the payment card application is governed by business rules requiring that activation of the contactless payment application for that card be managed within the payment card application stored in the local memory;
a wallet application stored within the local memory, wherein the wallet application contains business rules requiring that the wallet application be the single point of control for activating and deactivating applications;
a payment card payment application stored within the Secure Element; and
a wallet Secure Element application and wallet contact registry event listener application stored within the Secure Element.

2. The system of claim 1, wherein the user input interface is configured to allow a user to select a payment card application displayed on the mobile device display for activation.

3. The system of claim 2, further comprising a Secure Element platform configured to interact with the wallet Secure Element application to check for any conflicts resulting from a user selection of a payment card application for activation.

4. The system of claim 3, wherein the wallet Secure Element application communicates with the wallet application stored in the local memory, and wherein the wallet application stored in the local memory contains instructions to automatically launch a user interface for conflict resolution upon receipt of a communication from the wallet Secure Element application.

5. The system of claim 4, wherein the user interface includes selectable options allowing a user to manage activation and deactivation of payment card applications to resolve the conflict.

6. A method for resolving activation conflicts among mobile payment applications in a contactless mobile device, the method comprising:
transmitting an activation request from a payment card application stored in the local memory of a mobile device to a payment card payment application stored in a Secure Element of the mobile device;
transmitting a conflict check request to a Secure Element platform and wallet application stored in the Secure element, wherein the wallet application manages multiple payment card payment applications and controls activation and deactivation of the payment card payment applications;
detecting a conflict between the activation request and at least one other currently activated payment card application;
transmitting instructions from the wallet Secure Element application to a wallet application stored in the local memory to launch a user interface on a display of the mobile payment device; and
receiving instructions from a user through the user interface to resolve the activation conflict between payment card applications.

7. The method of claim 6, further comprising transmitting the user conflict resolution instructions to the wallet Secure Element application and a wallet contact registry event listener application, wherein the wallet Secure Element application and a wallet contact registry event listener application activate and deactivate payment card applications to resolve the conflict based on the user instructions.

8. The method of claim 6, further comprising transmitting a conflict detected notification to the payment card payment application.

9. The method of claim 8, further comprising transmitting a status request from the payment card payment application, and receiving an indication that the status has been activated at the payment card payment application upon completion of the conflict resolution.

10. The method of claim 1, further comprising activating the payment card application following resolution of the conflict.

11. A contactless mobile payment system comprising:
a mobile device comprising a display, user input interface, local memory and a Secure Element;
a service provider contactless payment application stored on the mobile device, the service provider application containing executable instructions for managing a contactless payment service;
a mobile wallet application stored on the mobile device, the mobile wallet application containing executable instructions for managing at least one service provider application;
a processor within the mobile device in communication with the service provider application and mobile wallet application, wherein the processor executes the instructions within the applications;
wherein the service provider application includes instructions allowing preferences to be set for management of the activation of the application, wherein at least one preference allows the service provider application to have its activation completely managed by the wallet application.

12. The system of claim 11, wherein the preferences within the service provider application are set by including flags within the application metadata.

13. The system of claim 12, wherein activation of the contactless payment service is completely managed by the wallet application when the preference flag is set to allow wallet activation.

14. The system of claim 12, wherein activation of the contactless payment service is maintained within the instructions of the service provider application when the flag is set such that wallet activation is not allowed.

15. The system of claim 13, further comprising a user interface display including a selectable option to enable or disable the contactless payment service when the flag is set to no and the contactless payment service is active.

16. The system of claim 13, further comprising a user interface display including a selectable option to launch the service provider application to activate the contactless payment service when the flag is set to no and the contactless payment service is inactive.

17. The method of claim 16, further comprising Personal Identification Number (PIN) verification instructions within the service provider application, wherein a PIN number must be input using a user interface within the service provider application and verified before instructions within the service provider application activate the contactless payment service.
